(19) United States
(12) Patent Application Publication
(10) Pub. No.: US 2013/0328699 A1
(43) Pub. Date: Dec. 12, 2013

(54) METHOD FOR DISPLAYING A RECOMMENDED CORNERING SPEED IN A VEHICLE AND DRIVER ASSISTANCE SYSTEM

(71) Applicant: GM GLOBAL TECHNOLOGY OPERATIONS LLC, Detroit, MI (US)

(72) Inventors: Thomas SCHRAMM, Mainz (DE); Gerald SCHMIDT, Frankfurt am Main (DE)

(73) Assignee: GM GLOBAL TECHNOLOGY OPERATIONS LLC, Detroit, MI (US)

(21) Appl. No.: 13/836,296

(22) Filed: Mar. 15, 2013

(30) Foreign Application Priority Data
Jun. 6, 2012 (DE) 10 2012 011 171.1

(51) Int. Cl. G08G 1/0967

(52) U.S. Cl. CPC G08G 1/0967
USPC 340/905

(57) ABSTRACT

A method for displaying a recommended cornering speed in a vehicle is provided. The method includes specifying a driving profile which is characterized by a number of parameters and ascertaining a recommended cornering speed for a bend to be maneuvered depending upon the geometry of the bend and depending upon the specified driving profile. The method includes outputting the recommended cornering speed to the driver.

### CROSS-REFERENCE TO RELATED APPLICATION

This application claims priority to German Patent Application No. 10 2012 011 171.1, filed Jun. 6, 2012, which is incorporated herein by reference in its entirety.

### TECHNICAL FIELD

The technical field relates to a method for displaying a recommended cornering speed in a vehicle. Furthermore it relates to a driver assistance system and a computer program product.

### BACKGROUND

In the DE 196 02 772 A1 a warning system for a vehicle has been disclosed which among others warns the driver not to drive at excessive speed when maneuvering a bend.

Nowadays driver assistance systems are used not only to avoid direct dangerous situations but also to relieve the burden on the driver, to increase driving comfort and to lower fuel consumption.

In addition, other objects, desirable features and characteristics will become apparent from the subsequent summary and detailed description, and the appended claims, taken in conjunction with the accompanying drawings and this background.

### SUMMARY

Accordingly, the present disclosure provides a method for displaying a recommended cornering speed in a vehicle as well as a driver assistance system, which issue information to the driver for selecting the right speed, in particular when driving through a bend, and which increase safety.

According to one exemplary aspect of the present disclosure a method for displaying a recommended cornering speed in a vehicle is proposed, wherein the method comprises the following steps: Specifying a driving profile which is characterized by a number of parameters, ascertaining a recommended cornering speed for driving through a bend depending upon the geometry of the bend and depending upon the specified driving profile, and issuing this recommended cornering speed to the driver.

The method makes it possible to issue a recommendation for a cornering speed, not merely on the basis of safety standards to be maintained at all costs. Rather it is possible to include further aspects and driver preferences in the recommendation. In particular the parameters characterizing the driving profile may include defaults regarding fuel consumption, sportiness of driving style and/or driving comfort.

For example, a driving profile may be characterized by a maximum degree of sportiness or driving dynamics. If this driving profile is specified a maximum possible cornering speed may be recommended, wherein however, a safety reserve is to be maintained. Such a driving profile characterized by maximum sportiness may therefore include, as an optimizing parameter, the shortest time required for a specified distance or the highest possible speed taking into account legal standards and traffic safety.

Alternatively a driving profile may be characterized by the most economical driving style, i.e. in particular as a result of low fuel consumption. If this driving profile is specified, the cornering speeds chosen will be automatically lower than those for a highly dynamic and sporty driving profile. Very low cornering speeds, however, are not recommended either because this might necessitate braking operations and subsequent fuel-consuming accelerations. With this driving profile the recommended speed could be issued earlier prior to reaching the bend so that the driver can avoid active braking and can utilize fuel-efficient rolling.

A driving profile characterized by maximum driving comfort may be defined by a minimum number of low-force braking operations and/or other forces acting upon the occupants (accelerations, lateral accelerations when maneuvering bends) and by altogether comparatively low speeds. If this driving profile is specified, lower cornering speeds are again recommended than for a driving profile characterized by a high level of driving dynamics and sportiness. The recommended speed is issued in good time prior to the bend in order to prevent sudden braking operations, but not as early as in one embodiment characterized by the most economical driving style.

The parameters characterizing the driving profile may therefore in particular be optimizing parameters such as driving time, average speed, fuel consumption, number of gear changes or braking operations and/or parameters relating to maximum values which must not be exceeded such as maximum accelerations or lateral accelerations.

Due to the method it is possible to issue recommendations to the driver which are tailored to match his needs. On the one hand this increases safety because wrong estimates of cornering speeds which frequently lead to accidents are avoided. On the other hand driving comfort is increased because the driver receives support tailored exactly to his needs and preferences when choosing the right cornering speed.

In one embodiment the driving profile is selected by the driver. The selection is made directly, i.e. in this embodiment the driver explicitly specifies the driving profile he desires, he can for example choose from a list of possible driving profiles or specify parameter settings characterizing the driving profile.

Alternatively the driving profile may be determined by a recognition of the driver, wherein recognition of the driver is carried out based on at least one user-specific setting of at least one component of the vehicle. For example recognition of the driver of the vehicle may be carried out based on a user-specific setting of a seat of the vehicle and/or a vehicle key.

This embodiment has the advantage that the driver himself does not have to select a driving profile, whilst nevertheless an individual driving profile is specified. This is advantageous, in particular, when the vehicle already comprises components or assistance systems which are adapted to suit the specific user.

In an alternative embodiment the driving profile is specified by copying parameters from a navigation system. Many navigation systems offer the possibility of selecting optimizing parameters such as “quickest route” or “most economic route”. These optimizing parameters are also suitable for specifying a driving profile for the method for displaying a recommended cornering speed. If the driving profile is set in this way, the driver needs to make only one selection, and navigation and recommendation of the cornering speed are carried out using the same optimizing parameters.

Also when specifying the driving profile, an average setting may be provided as a standard setting, which the driver can modify as required.

The recommended cornering speed is dependent not only upon the specified driving profile, but also upon the geometry of the bend. In order to be able to recommend a cornering speed, the geometry of the bend needs to be determined The geometry of the bend comprises all factors characterizing the layout of the bend which influence the cornering speed, in particular the radius of the bend. Further factors may be taken into consideration such as the camber of the carriageway or the width of the carriageway.

In one exemplary embodiment the geometry of the bend is ascertained based on satellite navigation data, for example GPS data. Alternatively or additionally the geometry of the bend may be ascertained by means of sensors on board the vehicle. Since the geometry of the bend is ascertained before the vehicle drives through the bend, suitable sensors such as cameras or radar sensors monitoring the carriageway would be used for this process.

Outputting the recommended cornering speed may be carried out optically, in particular. In one embodiment outputting the recommended cornering speed is effected by an optical display in a head-up display. Alternatively or additionally outputting the recommended cornering speed may be effected by an optical display in a combination instrument. The optical output of the recommended cornering speed has the advantage that it is of negligible nuisance to the driver, but is well visible as long as it is within his field of view.

Outputting the recommended cornering speed may also be effected acoustically. For example, a warning sound could alert the driver that he has exceeded, or is about to exceed, the recommended cornering speed. With this arrangement an increase in volume and/or an increase in frequency of a repeating warning sound could indicate that he is approaching or exceeding the recommended cornering speed.

In one exemplary embodiment the recommended cornering speed is ascertained utilizing the friction coefficient of the carriageway and/or normal loading of the vehicle and/or weather data and/or traffic data. With this embodiment further factors are considered in addition to the geometry of the bend, which have influence upon the recommended cornering speed. These factors are thus determined with a high degree of accuracy. With this embodiment it may therefore be possible to reduce a safety reserve when recommending the cornering speed.

According to one aspect of the present disclosure, a driver assistance system is provided for a vehicle, which comprises a first ascertainment device configured to specify a driving profile which is characterized by a number of parameters. The driver assistance system further comprises a second ascertainment device configured to ascertain a bend geometry, and a third ascertainment device configured to ascertain the recommended cornering speed for a bend to be maneuvered depending upon the bend geometry and depending upon the specified driving profile. The driver assistance system also comprises an output device which is configured to output the recommended cornering speed to the driver.

Furthermore one aspect of the present disclosure relates to a vehicle which comprises such a driver assistance system. The vehicle may, for example, be a motor vehicle, in particular a private car or a lorry.

In addition one aspect of the present disclosure relates to a computer program product which when executed on a computer unit of a driver assistance system for a vehicle, instructs the computer unit to perform the following steps:
Specifying a driving profile which is characterized by a number of parameters;
Ascertaining a recommended cornering speed for a bend to be maneuvered depending upon the geometry of the bend and depending upon the specified driving profile; and
Outputting the recommended cornering speed to the driver.

According to a further aspect of the present disclosure a computer-readable medium is provided on which such a computer program product is stored.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for displaying a recommended cornering speed in a vehicle according to one exemplary embodiment of the present disclosure; and

FIG. 2 shows a driver assistance system for a vehicle according to one exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

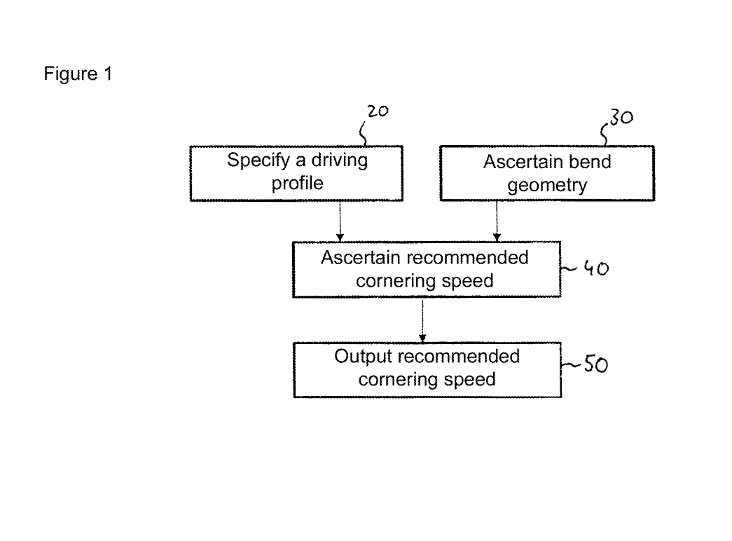

FIG. 1 shows a flow diagram of a method for displaying a recommended cornering speed in a vehicle according to one embodiment of the present disclosure.

In the embodiment shown, in step 20, a driving profile is specified. The driving profile is characterized by a number of parameters, for example by the desired average speed, the average fuel consumption, the number of gear changes or braking operations and/or parameters relating to maximum values not to be exceeded such as maximum accelerations or lateral accelerations. The driving profile may be specified by a setting made by the driver or by automatic recognition of the driver and/or his/her driving style.

In a step 30 the bend geometry of a bend to be maneuvered is ascertained. Ascertaining the bend geometry may, in particular, be carried out by evaluating satellite navigation data and/or by recognizing the bend by means of sensors on board the vehicle. In particular, this involves determining the radius of the bend.

In a step 40 the recommended cornering speed for the bend to be maneuvered is ascertained depending upon the geometry of the bend and depending upon the specified driving profile. The maximum possible cornering speed is ascertained taking the specified driving profile, the bend geometry as well as a safety reserve into account.

In a step 50 the recommended cornering speed is output to the driver. In particular the output is effected by means of an optical display in a head-up display and/or a combination instrument.

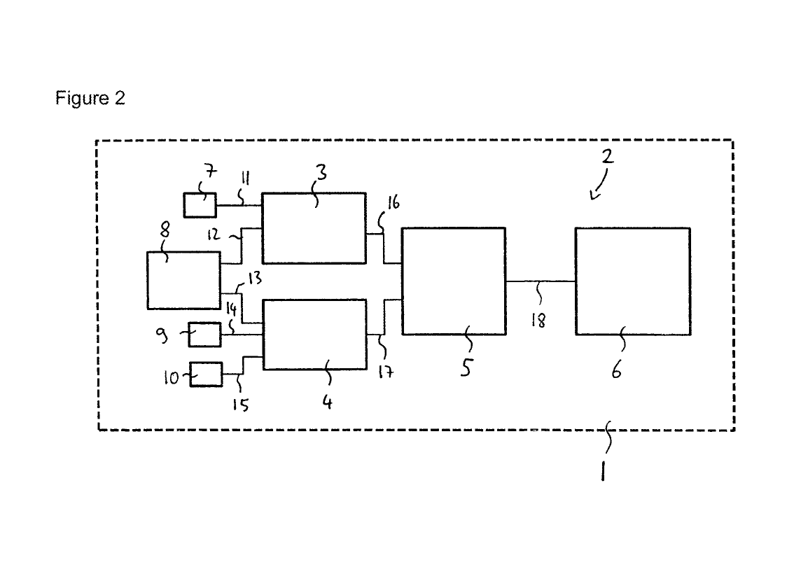

FIG. 2 shows a driver assistance system 2 for a schematically drawn vehicle 1 according one exemplary embodiment of the present disclosure, wherein the vehicle 1 may, for example, be a private car.

In the embodiment shown the driver assistance system 2 comprises a first ascertainment device 3 configured to specify a driving profile characterized by a number of parameters. The driving profile may be specified directly by the driver or may be selected from a list of previously specified settings. Or it may be specified by automatic recognition of the driver and/or the driving style, for which purpose the ascertainment device 3 is connected via a signal line 22 with a sensor 7 or several sensors.

The driving profile may also be determined by copying certain optimizing parameters from a navigation system 8. To this end the first ascertainment device 3 is connected via a signal line 12 with a navigation system 8.

In addition the driver assistance system 2 comprises a second ascertainment device 4 which is configured to ascertain the geometry of a bend. The bend geometry is determined based on satellite navigation data and/or sensors on board the vehicle. To this end the second ascertainment device 4 is connected via signal lines 13 to 15 with a navigation system 8 or with sensors 9, 10.

Further the driver assistance system 2 comprises an ascertainment device 5 which is configured to ascertain a recommended cornering speed for the bend to be maneuvered depending upon the bend geometry and depending upon the specified driving profile. To this end the third ascertainment device 5 is connected via a signal line 16 with the first ascertainment device 3 and via a signal line 17 with the second ascertainment device 4.

Further, the driver assistance system 2 comprises a display device 6 which is configured to output the recommended cornering speed to the driver. The display device may be configured, for example, as a combination instrument or as a head-up display and may be connected via a signal line 18 with the third ascertainment device 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. A method for displaying a recommended cornering speed in a vehicle, comprising:
specifying a driving profile which is characterized by a number of parameters;
ascertaining a recommended cornering speed for a bend to be maneuvered depending upon the geometry of the bend and depending upon the specified driving profile; and
outputting the recommended cornering speed to the driver.

2. The method according to claim 1, wherein the parameters characterizing the driving profile comprise at least one of defaults for fuel consumption, sportiness of driving style and driving comfort.

3. The method according to claim 1, wherein the driving profile is specified by the driver.

4. The method according to claim 1, wherein the driving profile is specified by a recognition of the driver, wherein recognizing the driver is effected based on at least one user-specific setting of at least one component of the vehicle.

5. The method according to claim 4, wherein recognizing the driver is effected based on at least one of a user-specific setting of a seat of the vehicle and a vehicle key.

6. The method according to claim 1, wherein a driving profile is specified by copying parameters from a navigation system.

7. The method according to claim 1, wherein the bend geometry is ascertained by means of satellite navigation data.

8. The method according to claim 1, wherein the bend geometry is ascertained by means of sensors on board the vehicle.

9. The method according to claim 1, wherein outputting the recommended cornering speed is effected by an optical display in a head-up display.

10. The method according to claim 1, wherein outputting the recommended cornering speed is effected by a combination instrument.

11. The method according to claim 1, wherein outputting the recommended cornering speed is effected acoustically.

12. The method according to claim 1, wherein the recommended cornering speed is ascertained utilizing at least one of a friction coefficient of the carriageway, a normal loading of the vehicle, weather data and traffic data.

13. A driver assistance system for a vehicle, comprising:
a first ascertainment device configured to specify a driving profile characterized by a number of parameters;
a second ascertainment device configured to ascertain a bend geometry;
a third ascertainment device configured to ascertain the recommended cornering speed for a bend to be maneuvered depending upon the bend geometry and depending upon the specified driving profile; and
an output device configured to output the recommended cornering speed to the driver.

14. A computer readable medium embodying a computer program product which when executed on a computer unit of a driver assistance system for a vehicle, instructs the computer unit to execute the following steps:
specifying a driving profile which is characterized by a number of parameters;
ascertaining a recommended cornering speed for a bend to be maneuvered depending upon the geometry of the bend and depending upon the specified driving profile; and
outputting the recommended cornering speed to the driver.

15. (canceled)
